(19) United States
(12) Patent Application Publication
(10) Pub. No.: US 2013/0206263 A1
(43) Pub. Date: Aug. 15, 2013

(54) VORTEX CONTROL APPARATUS

(71) Applicants: Anthony Brownlow, Salt Lake City, UT (US); William Richardson, Salt Lake City, UT (US)

(72) Inventors: Anthony Brownlow, Salt Lake City, UT (US); William Richardson, Salt Lake City, UT (US)

(21) Appl. No.: 13/372,330

(22) Filed: Feb. 13, 2012

(51) Int. Cl. F15C 1/16

(52) U.S. Cl. 137/810

(57) ABSTRACT

A vortex control apparatus is disclosed which has a unit body extending longitudinally along a central axis. The unit body has a plurality of primary fins extending radially from its central axis. The unit body also has a plurality of secondary fins extending radially from its central axis. Each of the plurality of primary fins can be spaced apart and be positioned disposed between two primary fins. The vortex control apparatus can also include a flange coupled to the unit body that extending radially from the central axis of the unit body. The flange can also extend radially from the central axis of the unit body farther than primary fins or the secondary fins.

### BACKGROUND

1. Field of the Invention

This application relates generally to vortex control apparatuses. More specifically, this application relates to systems and apparatuses for reducing the likelihood of a vortex in liquids flowing in or into a pipe.

2. Background of the Invention and Related Art

In tanks holding liquids, a lighter liquid such as hydrocarbons separate from and sit on top of denser liquids such as water used to extract the hydrocarbons below. Usually an extraction port or valve sits near the bottom of such tanks and the lower liquid can be extracted via the extraction port or valve—sometimes by virtue of gravity but often using a mechanical vacuum or other pump to increase the speed of extraction. Whether under gravity or even more so under force of accelerated extraction, as the liquid is extracted from the tank, a vortex forms that allows top and bottom fluids to be pulled simultaneously form the tank. This is undesirable as the hydrocarbons may be pollutants, rendering the more dense water unfit for certain types of disposal. Also, the hydrocarbons are valuable, thus dispensing of them with water as a waste costs a producer money.

### SUMMARY

In light of the tendency for a vortex to occur in tanks, outlets, and pipes the present invention relates to a vortex control systems and apparatus that can reduce or eliminate the occurrence of vortices in liquid flowing into a pipe. In some aspects, the vortex control apparatus has a unit body extending longitudinally along a central axis. The unit body can have a plurality of primary fins extending radially from its central axis. Each of the plurality of primary fins can be equally spaced apart. The unit body can also have a plurality of secondary fins extending radially from its central axis. Each of the plurality of primary fins can be spaced equidistantly apart and be positioned between two adjacent primary fins. The vortex control apparatus can also include a flange coupled to the unit body that extends radially from the central axis of the unit body. The flange can be offset from the center of the unit body along the central axis of the unit body. The flange can also extend radially from the central axis of the unit body farther than primary fins or the secondary fins. In some instances, in use, the flange of the vortex control apparatus can be secured to a flange joint of a tank outlet. As fluid flows out the outlet, the plurality of primary and secondary fins can reduce or eliminate the occurrence of vortices in the tank, outlet and/or the pipe.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings.

FIG. 1 illustrates a side view of embodiments of a representative vortex control apparatus.

FIG. 2 illustrates an end view of embodiments of a representative vortex control apparatus.

FIG. 3 illustrates an end view of represent embodiments of an isolated, representative unit body of a vortex control apparatus.

FIG. 4 illustrates a partial cutaway, side view of embodiments of a representative vortex control apparatus in a tank outlet.

FIG. 5A illustrates a side, perspective view of a representative embodiment of a vortex control device.

FIG. 5B illustrates a perspective view of a representative embodiment of a vortex control device.

### DETAILED DESCRIPTION OF THE INVENTION

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).”

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in some embodiments,” which may each refer to one or more of the same or different embodiments. Furthermore, the terms “comprising,” “including,” “having,” and the like, as used with respect to embodiments of the present invention, are synonymous with the definition afforded the term “comprising.”

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical or electrical contact. However, “coupled” may also mean that two or more elements are not in direct contact with each other, but yet still cooperate or interact with each other.

The term “distal” refers to a location on an apparatus that is farthest into an outlet tube from the entry of the outlet within a container or tank. Additionally, the term “proximal” conversely refers to a location on an apparatus that is closest to within tank or container or entry of the outlet and/or the least far into the outlet tube from the entry of the outlet within a container.

This application relates generally to vortex control apparatuses. More specifically, this application relates to systems and apparatuses for reducing the likelihood of a vortex in liquids flowing in or into a pipe.

In light of the tendency for a vortex to occur in tanks, outlets, and pipes the present invention relates to a vortex control systems and apparatus that can reduce or eliminate the occurrence of vortices in liquid flowing into a pipe. In some aspects, the vortex control apparatus has a unit body extending longitudinally along a central axis. The unit body can have a plurality of primary fins extending radially from its central axis. Each of the plurality of primary fins can be equally spaced apart. The unit body can also have a plurality of secondary fins extending radially from its central axis. Each of the plurality of primary fins can be spaced equidistantly apart and be positioned between two adjacent primary fins. The vortex control apparatus can also include a flange coupled to the unit body that extends radially from the central axis of the unit body. The flange can be offset from the center of the unit body along the central axis of the unit body. The flange can also extend radially from the central axis of the unit body rather than primary fins or the secondary fins. In some instances, in use, the flange of the vortex control apparatus can be secured to a flange joint of a tank outlet. As fluid flows out the outlet, the plurality of primary and secondary fins can reduce or eliminate the occurrence of vortices in the tank, outlet and/or the pipe by inducing turbulence or by shifting the location of the lowest pressure point in the tank, outlet, and/or pipe.

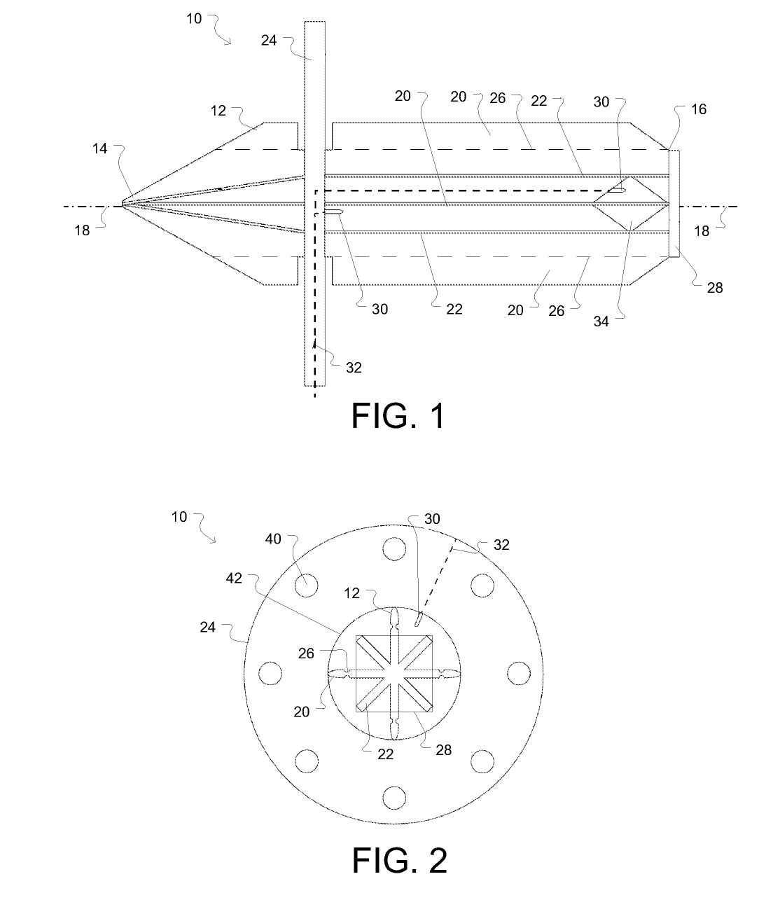

Reference will now be made to specific embodiments of vortex control apparatuses illustrated in the Figures. Reference will first be made to FIG. 1, which depicts a vortex control apparatus 10 that extends between a distal end 14 and a proximal end 16 longitudinally along a central axis 18. The distal end 14 of the vortex control apparatus is configured to induce laminar flow while the proximal end is configured to induce turbulent flow. The unit body 12 can have primary fins 20 and second fins 22. A flange 24 can be coupled to the unit body 12. A plate 28 can be connected to the proximal end 16, and a scrambling member can be connected to a proximal portion of the unit body 12.

In some embodiments, the vortex control apparatus 10, including all of its component parts, is made from any desirable material with suitable properties and/or characteristics. By way of non-limiting example, in some embodiments, the vortex control apparatus 10 is made of one or more of the following materials or combinations thereof: metallic materials, polymer materials, composite materials, synthetic materials, wood or fibrous materials, or resins. In such embodiments, the desirable or selected material is homogenous or uniform throughout while in other embodiments the selected material includes voids or encapsulates non-homogenous materials. In some embodiments, the material selected is dictated by the intended use of vortex control apparatus 10. For example, in embodiments wherein vortex control apparatus 10 is intended to endure significant and/or sustained stress or external forces, vortex control apparatus 10 is constructed out of high strength and/or non-breakable materials, such as steel. In other embodiments, for example, wherein the vortex control apparatus 10 is intended to be in a liquid environment for extended periods of time, the vortex control apparatus 10 can be constructed of a corrosion and/or rust resistant material, such as stainless steel, a composite material, or a polymer material.

In some embodiments, the vortex control apparatus 10, including all of its constituent parts, are constructed out of the same material. For example, in some embodiments, the unit body 12 the primary fins 20, the secondary fins 22, the plate 28, the scrambling member 34, and the flange 24 are all constructed out of the same material, such as metal, composite, or polymer. In other embodiments, however, one or more constituent elements of the vortex control apparatus 10 is/are constructed out of a material that is different from the material of one or more of the remaining constituent elements of the vortex control apparatus 10.

In addition, in some embodiments, the vortex control apparatus 10, including its component elements, is manufactured by any suitable method. By way of non-limiting example, in some embodiments, some or all of the component parts of the vortex control apparatus 10 is/are manufactured by one or more of the following methods: injection molding, rotational molding, casting and/or other molding processes, machining, cutting, carving, routing, punching, milling and/or other suitable forming or manufacturing processes. In some embodiments, each component part of the vortex control apparatus 10 is manufactured using the same method while in other embodiments one or more of the component parts of vortex control apparatus 10 is/are manufactured using a method that is different from the method used to manufacture one or more of the remaining component parts of the vortex control apparatus 10.

Moreover, in some embodiments, the component parts of the vortex control apparatus 10 are manufactured separately and assembled to form the vortex control apparatus 10. In such embodiments, for example, the component parts of the vortex control apparatus 10 are fixed in relative position to one another on a permanent or semi-permanent basis by one or more of the following illustrative means: glue and/or other adhesives, ultrasonic welding, welding, nut and bolt combinations and other suitable methods known in the art for joining or retaining similar or dissimilar component parts together or in relative position to one another on a permanent or semi-permanent basis. In other embodiments, the vortex control apparatus 10 is integrally manufactured or formed as a single unit. In such embodiments, the vortex control apparatus 10 is either formed as a single unit or more specifically, a single-piece unit, such as by casting or molding processes. Or the vortex control apparatus 10 can be formed from a solid homogenous stock material or solid core product, such as by machining or milling processes.

In some embodiments, the material selected for one or more of the component parts of the vortex control apparatus 10 dictates the suitable method of manufacture. For example, in embodiments wherein a component part of the vortex control apparatus 10 is manufactured out of steel, a casting or machining method of manufacture is used. As another example, in embodiments wherein a component part of the vortex control apparatus 10 is manufactured out of plastic, injection molding is an appropriate method of manufacturing such component part(s).

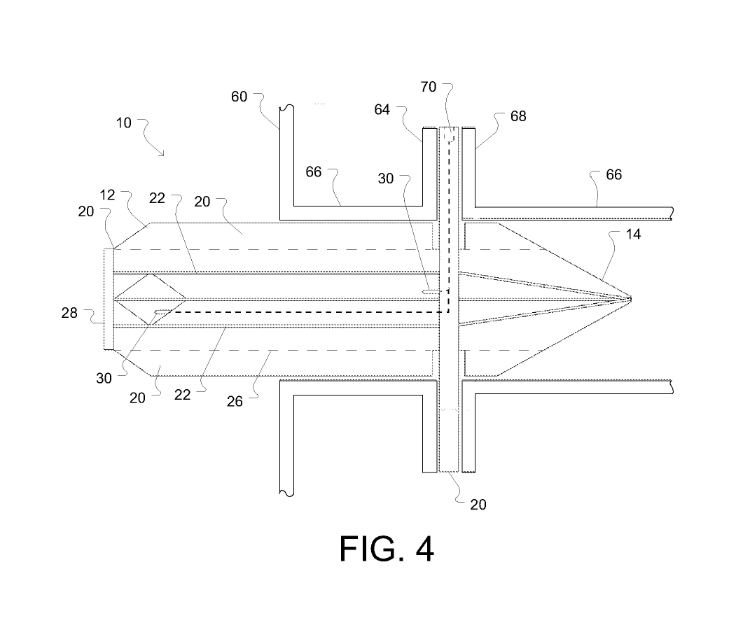

Referring still to FIG. 1, reference will now be made to the specific component parts and functions of the vortex control apparatus 10. As shown, the vortex control apparatus 10 can include a unit body 12 that extends longitudinally along a central axis 18. The unit body 12 has a distal end 14 and a proximal end 16. The distal end 14 is the portion which is intended to be inserted the farthest into an outlet tube from the entry of the outlet within a container or tank during use as shown in FIG. 4. Additionally, proximal end 16 is the portion closest to the interior of a tank or container or entry of the outlet and/or extends the least distance into an outlet tube. In some embodiments, the unit body 12 has a generally ribbed-arrowhead shape, with a pointed distal end 14 and a blunt proximal end 16. The ribbed-arrowhead shape can help to induce and return fluid flow to a laminar flow path around the unit body 12 than mixing the flow. Laminar flow may be induced by using a rough surface on a surface of the unit body 14. Alternative exemplary embodiments creating shapes or contours on the unit body 12 that may direct fluid flow to a desired path. Such shapes may include tear drop shapes or foil shapes.

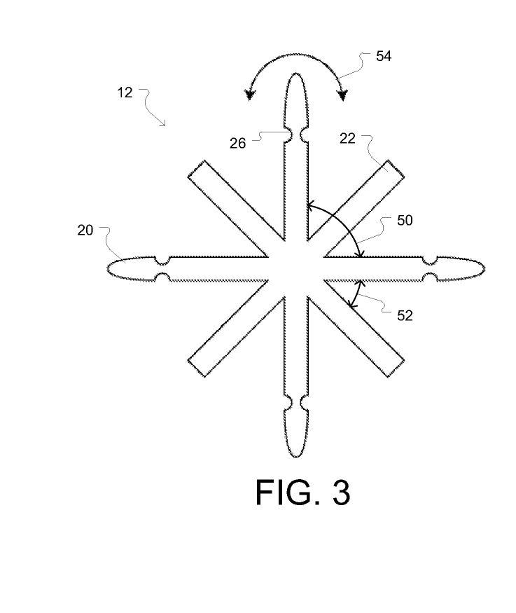

As shown, the unit body 12 can have a two or more primary fins 20. The primary fins 20 can extend radially from the central axis 18 and run longitudinally to the central axis 18. In some instances, each primary fin 20 is substantially flat, and can extend along a substantially planar surface. In some configurations, the unit body 12 includes between two and eight primary fins 20, including three primary fins 20, four primary fins 20, five primary fins 20, six primary fins 20, seven primary fins 20, or eight primary fins 20. In other configurations, the unit body 12 can include more than eight primary fins 20. In some specific configurations, the unit body 12 include four primary fins 20 as shown in FIG. 1. Each of the primary fins 20 can be spaced equidistantly apart, as shown in FIGS. 2 and 3 or spaced asymmetrically. In some exemplary embodiments, fins or portions of fans may be hinged to allow the fin to rotate toward a low pressure and disturbs the flow. Optionally, each of the primary fins 20 can include a notch 26 that extends along the longitudinal length of the fin. The notches 26 will be described in greater detail in respect to FIG. 3.

Alone, these primary fins 20 may reduce the likelihood of initial vortexing within a tank or pipe by increasing the turbulence in the flow. However, under some circumstances, secondary vortexing within the areas between the primary fins 20 still can occur, particularly when the liquid level in a tank or other holding container becomes very low and the pressure force necessary to induce the vortex is low. Accordingly, the unit body 12 can include a plurality of secondary fins 22 between each of the primary fins 20. The secondary fins 22 can extend radially from the central axis 18 a shorter distance than the primary fins 20. Alternatively, the secondary fins can extend approximately the same distance from the central axis 18 as the primary fins 20. In some instance, the primary and secondary fins 20, 22 are substantially identical while in other instances they differ in shape, size, length, or other structural features. As shown in each of the plurality of secondary fins 22 can be spaced substantially the same distance apart. Moreover, each of the secondary fins 22 can be positioned between two primary fins 20. In this way, the primary fins 20 and the secondary fins 22 can be positioned in an alternating fashion around the central axis 18.

As shown, a flange 24 can be coupled to the unit body 12. The flange 24 can be positioned at any location along the central axis 18 of the unit body 12. However, in some embodiments, the flange 24 is not positioned at the distal end 14 or proximal 12. Additionally, in some embodiments, the flange 24 is not positioned in the center of the unit body 12 along the central axis 18, but is offset from the center, as shown. This offset positioning of the flange 24 can include forward and rearward leverage on the unit body 12 during use that can reduce any pressure on the flange connection with the unit body 12 to ensuring less chance of failure at this connection. Without this offsetting, pressures applied on the flange 24 at a deviance from 90-degrees can lead to strain on the flange connection and material, deformation or catastrophic failure. Additionally, under some circumstances, positioning the flange 24 at the distal end 14 or proximal end 16 lead to imbalance and pressure at the one-sided connection of the flange 24 or other fitting, which can in turn lead to material fatigue and cracking.

As shown, the flange 24 can extend radially from a central axis 18 farther than the primary fins 20 and secondary fins 22. This extension can enable the flange to extend beyond the inner diameter of a pipe or tube (not shown) and be connected to a pipe flange and/or outlet flange (68 and 62 respectively in FIG. 4), as shown in FIG. 4.

FIG. 1 further illustrates a plate 28 coupled to the blunt proximal end 16 of the unit body 12. The blunt proximal end 16 of the unit body 12 can partially obstruct fluid flow with the plate 28 to induce cavitation or at least partially prevent or reduce laminar fluid flow around the unit body 12.

Alternative exemplary embodiments teach the plate is a rotating, multi-bladed blender blade or prop, like the prop on a boat that my rotate with the flow of fluid is induced by the fluid flow. Alternatively, the prop may flow under an alternative power source so its rate of rotation is substantially independent of the fluid's flow speed.

Additionally, the unit body 12 can include a scrambling member 34 coupled to a proximal portion of the unit body 12. In addition to primary fins 20 and secondary fins 22, the scrambling member 34 and the openings that are naturally formed in blunt proximal end 16 during use (as shown in FIG. 4) can cause cavitation scramble, or break up, laminar fluid flow and increase multi-directional fluid flow to the outlet pipe, which can induce turbulence and thus reduce the prospect of vortexing.

In some embodiments, the scrambling member 34 is a pivoting member that pivots back and forth when in the path of fluid flow so that a free-pivot end of the member is sucked towards a low-pressure region in the fluid flow. This teetering can create high and low pressures, which disrupt the laminar flow of the fluid, creating turbulence and disrupt the occurrence of vortices.

As further shown in FIG. 1, the vortex control apparatus 10 can include one or more temperature sensors 30. These temperature sensors 30 can measure the in site temperature at the output location of a tank, which can be a location that can be monitored and recorded to help determine the extent to which the hydrocarbons and the water are separated. Accordingly, in some configurations, the temperature sensor(s) 30 can be electronically coupled to a sensor system and/or computer system can receives sensor data from the temperature sensor 30 to identify the temperature of fluid flowing therethrough. Various types of temperature sensors 30 can be utilized with the vortex control apparatus 10, as are known in the art. As shown, a temperature sensor 30 can be coupled to the flange and/or the unit body 12, such as on a proximal portion of the unit body 12 and the sensor's data can be monitored by the user when an instrument is plugged into the sensor's port.

Reference will now be made to FIG. 2, which depicts a proximal end view of the vortex control apparatus 10, with the plate 28 being transparent for illustration purposes. As shown, the unit body 12 can include multiple primary fins 20 and secondary fins 22 extending radially therefrom such as for primary fins 20 and four secondary fins 22. In some embodiments, the primary fins 20 can extend radially farther from the central axis 18 than the secondary fins 22 and the flange 24 can extend radially farther than the primary fins 20. In other embodiments, the primary and secondary fins extend radially about the same distance. In such exemplary embodiments the primary and secondary fins are similar, comprising 6, 8, or 10. Moreover, in some configurations, one or more portions of the proximal plate 28 can extend radially from the central axis 18 about the same distance as the secondary fins 22. The flange 24 can include an opening 42 to facilitate fluid flow therethrough and one or more holes 40 for coupling to the tank outlet and/or an outlet pipe, as shown in FIG. 4.

Reference will now be made to FIG. 3, which illustrates an end view of an isolated unit body 12. As shown, in some embodiments, the unit body 12 includes four primary fins 20 each of which is oriented orthogonally to another primary fin 12. Thus, the angle 50 between adjacent primary fins 20 can be approximately 90-degrees. Additionally, each of the primary fins 20 can be spaced apart either symmetrically or asymmetrically. Furthermore, the unit body 12 can includes four secondary fins 22, each of the four primary fins being oriented at about an angle 52 of approximately 45-degree to an adjacent primary fin 20. Moreover, in some instances, as mentioned, each of the secondary fins 22 extending radially a lesser distance than each of the primary fins 20. The fins may be racially parallel or radially non-parallel.

FIG. 3 also illustrates a notch 26 formed in each of the primary fins 20. The notch 26 can enable the unit body 12 to be inserted into pipes of various sizes. For example, if the inner diameter of a pipe is smaller than the cross sectional length of each primary fin 20, the primary fins 20 can bend in a pivotal direction 54 about the notch 26 to facilitate insertion of the unit body 12 into the pipe. Thus, the unit body 12 can be retro-fitted to the extraction pipe of tanks and the device having a range of pipe diameter sizes. Furthermore, this ability can be varied according to where the notch 26 is placed on the primary fin 20 and the flexibility of the material of manufacture. When the device is inserted into a pipe with a diameter that is smaller than that of the pipe the fin can bend sufficiently to accommodate the difference thus enabling one device to fit many pipe sizes. The notch may also allow the fin to fracture so a portion of the fin beyond the notch will create and be removed from apparatus 10.

Reference will now be made to FIG. 4, which illustrates a partial cutaway, side view of embodiments of a representative vortex control apparatus 10 in a tank outlet. As shown, the vortex control device 10 can be inserted into a tank outlet 62 and an outlet pipe 66. The vortex control device 10 can be held in place as its flange 24 is compressed and affixed between an outlet flange 64 and a pipe flange 68. Further, as shown, a proximal portion of the unit body 12 can extend beyond the tank wall 60 and into a tank. As fluid flows into the outlet, it passes through and around the unit body 12 with its primary fins 20 and secondary fins 22, which can resist vortices. Moreover, in addition to primary fins 20 and secondary fins 22, the scrambling member 34 and the openings that are naturally formed in blunt proximal end 16 during use (as shown in FIG. 4) can scramble, or break up, regular fluid flow and to increase multi-directional access to the outlet pipe, which can reduce the prospect of vortexing. In this way, the vortex control device 10 can reduce or eliminate the occurrence of vortices in outlet.

Thus, as discussed herein, embodiments of the present invention embrace vortex control apparatuses 10.

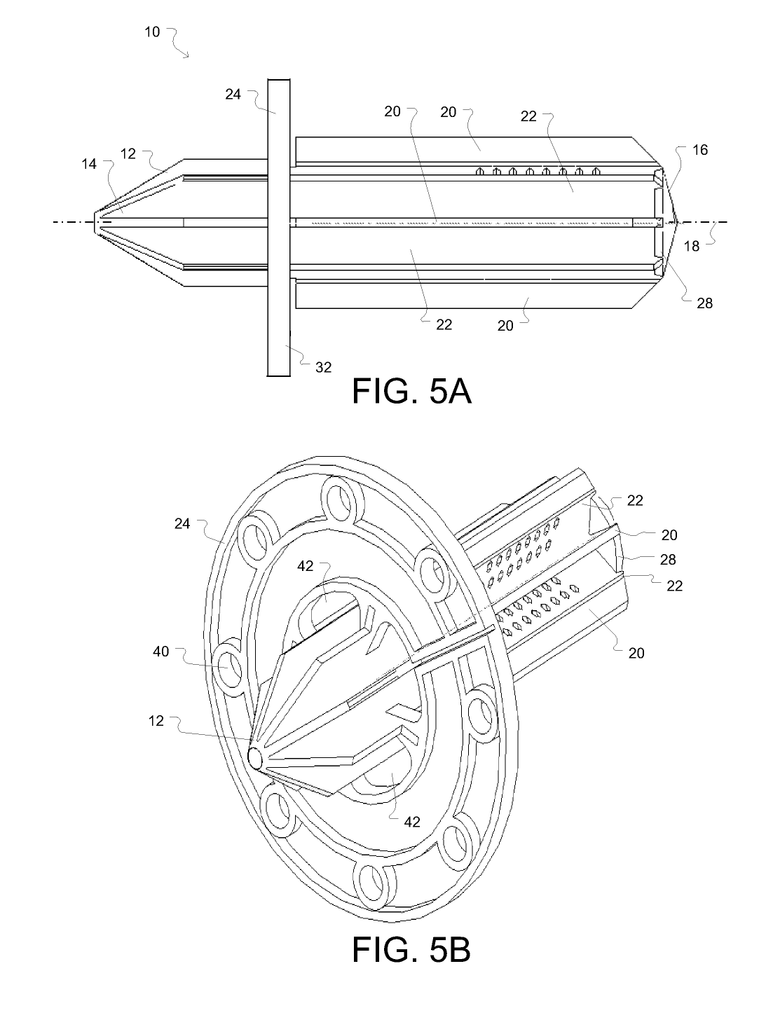

FIGS. 5A and 5B illustrate other embodiments of a vortex control device.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A vortex control apparatus comprising:
a unit body extending longitudinally along a central axis;
a plurality of primary fins of the unit body extending radially from the central axis, each of the plurality of primary fins being spaced apart;
a plurality of secondary fins of the unit body extending radially from the central axis, each of the plurality of secondary fins being spaced apart, each of the plurality of secondary fins being disposed between two of the plurality of primary fins; and
a flange coupled to the unit body and extending radially from the central axis, the flange being offset from the center of the unit body along the central axis, the flange extending radially from a central axis farther than the plurality of primary fins and the plurality of secondary fins.

2. The vortex control apparatus of claim 1, wherein the plurality of primary fins includes between three and eight primary fins.

3. The vortex control apparatus of claim 1, wherein the plurality of primary fins includes four primary fins, each of the primary fins being oriented orthogonally to another primary fin.

4. The vortex control apparatus of claim 3, wherein the plurality of secondary fins includes four secondary fins, each of the four primary fins being oriented at about a 45-degree angle to an adjacent primary fin.

5. The vortex control apparatus of claim 1, wherein each of the plurality of secondary fins extends radially a lesser distance than each of the plurality primary fins.

6. The vortex control apparatus of claim 1, further comprising a notch formed in each of the plurality of primary fins, the notch extending along the longitudinal length of the primary fin.

7. The vortex control apparatus of claim 1, wherein the unit body has a laminar flow inducing a pointed distal end and a turbulent flow inducing blunt proximal end.

8. The vortex control apparatus of claim 7, further comprising a plate coupled to the blunt proximal end of the unit body.

9. The vortex control apparatus of claim 8, wherein at least a portion of the plate extends radially from the central axis about the same distance as the plurality of secondary fins.

10. The vortex control apparatus of claim 7, further comprising a scrambling member coupled to a proximate portion of the unit body.

11. The vortex control apparatus of claim 1, further comprising a temperature sensor coupled to the flange.

12. The vortex control apparatus of claim 1, further comprising a temperature sensor coupled to the unit body.

13. A vortex control apparatus comprising:
a unit body extending longitudinally along a central axis;
four primary fins of the unit body extending radially from the central axis;
four secondary fins of the unit body extending radially from the central axis, each of the four primary fins being oriented at about a 45-degree angle to an adjacent primary fin;
a flange coupled to the unit body and extending radially from the central axis, the flange being offset from the center of the unit body along the central axis, the flange extending radially farther than the primary fins; and
a temperature sensor disposed in the primary body.

14. The vortex control apparatus of claim 13, further comprising a notch formed in each of the four primary fins, the notch extending along the longitudinal length of the primary fin.

15. The vortex control apparatus of claim 13, wherein the unit body has a pointed distal end wherein the surface of the distal end is rough and induces laminar flow and a blunt proximal end.

16. The vortex control apparatus of claim 15, further comprising a plate coupled to the blunt proximal end of the unit body.

17. The vortex control apparatus of claim 16, wherein at least a portion of the plate extends radially from the central axis about the same distance as the plurality of secondary fins.

18. The vortex control apparatus of claim 15, further comprising a scrambling member coupled to a proximal portion of the unit body.

19. The vortex control apparatus of claim 13, further comprising a temperature sensor coupled to the flange or the unit body.

20. A vortex control apparatus comprising:
a unit body extending longitudinally along a central axis, the unit body having a pointed distal end and a blunt proximal end;
four primary fins of the unit body extending radially from the central axis, each of the primary fins being oriented orthogonally to another primary fin, each of the four primary fins having notch extending along the longitudinal length of the fin;
four secondary fins of the unit body extending radially from the central axis, each of the four primary fins being oriented at about a 45-degree angle to an adjacent primary fin, the four secondary fins extending radially;
a flange coupled orthogonally to the unit body and extending radially from the central axis, the flange being distally offset from the center of the unit body along the central axis, the flange extending radially farther than the primary fins;
a proximal plate coupled to the blunt proximal end, wherein the proximal plate extends radially from the central axis about the same distance as the secondary fins;
a temperature sensor coupled to the unit body or the flange; and
a scrambling member coupled to a proximal portion of the unit body.
